(19) United States
(12) Patent Application Publication
(10) Pub. No.: US 2001/0045794 A1
(43) Pub. Date: Nov. 29, 2001

(54) Cap layer on glass panels for improving tip uniformity in cold cathode field emission technology

(76) Inventors: James J. Alwan, Boise, ID (US); Behnam Moradi, Boise, ID (US); Kevin Tjaden, Boise, ID (US)

Correspondence Address: Wayne M. Kennard, Hale and Dorr LLP, 60 State Street, Boston, MA, 02109, US

(21) Appl. No.: 09/910,542

(22) Filed: Jul. 20, 2001

Related U.S. Application Data
(63) Continuation of application No. 08/589,040, filed on Jan. 19, 1996, now abandoned.

(51) Int. Cl. H01J 1/16

(52) U.S. Cl. 313/336; 313/309

(57) ABSTRACT

A cap layer is placed on a substrate of inexpensive glass prior to subsequent processing to form emitter tips. The cap layer substantially reduces shrinkage of the substrate, significantly improves uniform formation of silicon tips, and substantially eliminates delamination of silicon layers from the substrate.

### GOVERNMENT RIGHTS

This invention was made with Government support under Contract No. DABT63-93-C-0025 awarded by the Advanced Research Projects Agency (ARPA). The Government has certain rights in this invention.

### BACKGROUND OF THE INVENTION

The present invention pertains to a method for improving the uniformity of tip placement in cold cathode field emission technology and the improved product, particularly the cathode, resulting therefrom.

Field emission display (FED) technology utilizes a matrix addressable array of pointed, thin film, cold field emission cathodes in combination with a phosphor luminescent screen, as represented for example by U.S. Pat. No. 5,210,472, the disclosure of which is incorporated herein by reference. An emissive flat panel display operates on the principles of cathodoluminescent phosphors excited by cold cathode field emission electrons. A faceplate having a cathodoluminescent phosphor coating receives patterned electron bombardment from an opposing cathode thereby providing a light image which can be seen by a viewer. The faceplate is separated from the cathode by a vacuum gap and, in some embodiments, the face plate and the cathode are prevented from collapsing together by physical standoffs or spacers fixed between them. In some embodiments the cathode is integrally formed with a back plate, while in others the back plate is separate from the cathode, surrounds the cathode and is sealed to the face plate.

The cathode of a field emission display is comprised of arrays of emission sites (emitters) which are typically sharp cones that produce electron emission in the presence of an intense electric field. An extraction grid disposed relative to the sharp emitters provides the intense positive voltage for the electric field.

FEDs have heretofore required that high quality (and thus expensive) glass or single crystalline silicon be used for the cathode substrate. This requirement has been necessary to avoid shrinkage of the cathode substrate during subsequent processing and to prevent layers from delamination.

Current processes for making large area field emission flat panel displays are expensive due to several requirements, including having a cathode substrate with a flawless, smooth and slat surface with reasonable chemical durability. Another important parameter that must be considered is the above mentioned shrinkage problem. The shrinkage of the cathode substrate, after heat processing, is important when making a pattern on a large substrate as shrinkage causes misalignment between patterns on the substrate. Further still, the substrate from which the cathode tips (and circuitry therefor) is made, must traditionally contain no, or few, impurities. Otherwise, during operations, the impurities will migrate into the tips or control circuitry, thus affecting performance. Therefore, expensive glass which is thermally matched to silicon, or single crystalline silicon, itself, has been traditionally used as the substrate on which a cathode is made. Therefore, there is a need for a less expensive substrate with reasonable quality for mass production of field emission displays.

An example of the prior art may be found in U.S. Pat. No. 4,857,161, the disclosure of which is incorporated herein by reference.

### SUMMARY OF THE INVENTION

The present invention concerns a method for improving the uniformity in tip location in cold cathode field emission devices, particularly those of large scale, by initially placing a cap layer on a cathode substrate, prior to processing and the resulting product. Thus the present invention has the ability to make more uniform silicon tips while substantially eliminating delamination of silicon layers.

### BRIEF DESCRIPTION OF THE DRAWINGS

The present invention will now be described by way of example, with reference to the accompanying drawings, in which:

FIG. 1 is a schematic cross section through an FED in accordance with the prior art; and

FIG. 2 is a schematic cross section through an FED in accordance with the present invention.

### DETAILED DESCRIPTION OF AN ILLUSTRATIVE EMBODIMENT

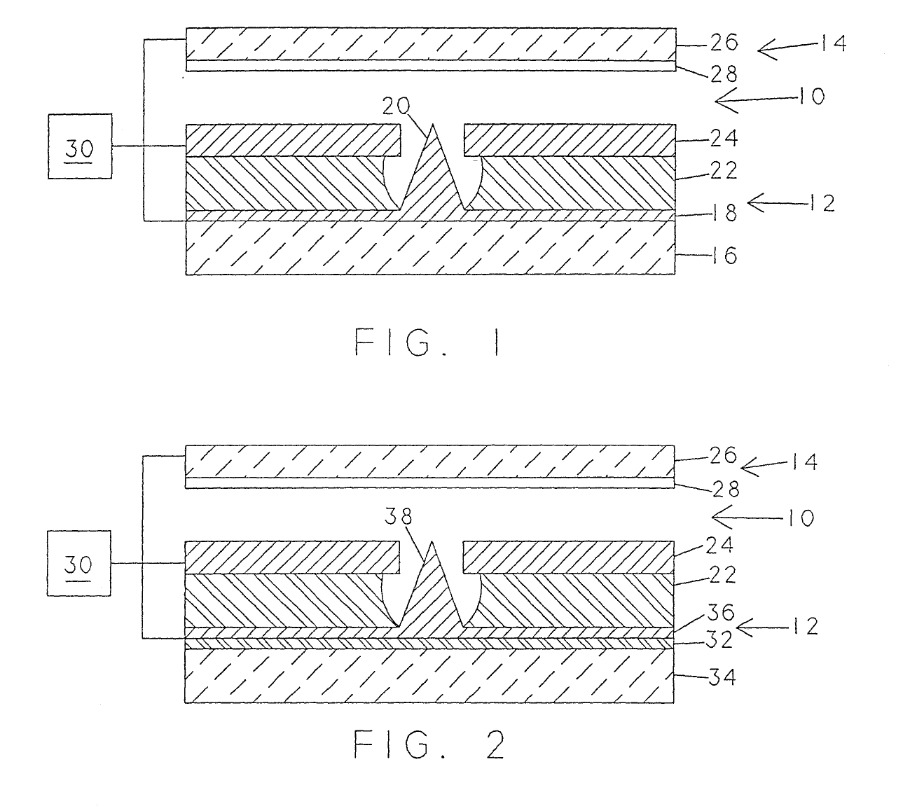

Referring to FIG. 1, a field emission display 10 employing a cold cathode 12 and an opposing spaced anode 14 is shown. The cathode 12 has a substrate 16, which has been comprised of a glass matched to the characteristics of silicon, as explained above. The substrate 16 is coated with a conductive layer 18, such as amorphous silicon, microcrystalline silicon or polysilicon, and, at each emission site, conical micro-cathode emitters 20 are formed on the conductive layer 18. An insulator 22 separates a grid 24 from the conductive layer 18. The anode 14 is a transparent glass 26 coated with phosphors 28. This assembly is sealed in a package (not shown) and a high vacuum is drawn inside the package. The cathode 12, grid 24 and anode 14 are connected to electrical source 30. When a voltage differential, from source 30, is applied between cathode 12 and grid 24, a stream of electrons is emitted towards the phosphors 28 of the anode 14.

One example embodiment of the present invention improves the above-described display, shown in FIG. 1, by depositing a cap layer 32 directly on the surface of an inexpensive substrate 34, such as a soda-lime glass or plastics material substrate, followed by the conductive layer 36 from which tips 38 are formed. Examples of acceptable materials for the cap layer 32 include a silicon dioxide (SiO₂), silicon nitride (Si₃N₄), silicon carbide or polycrystalline carbon. The cap layer need have a thickness of only 0.10 microns.

One acceptable method for making such a cap layer 32 is a plasma enhanced, chemical vapor deposition having the following process parameters:

SiH₄=100 standard cubic cm/min (sccm)

N₂O=2000 sccm

N₂=900 sccm

Power=900 watts

Pressure=1 Torr

Temperature=300° C.

Next, Si film is deposited over the cap layer by the following process:

SiH₄=800 sccm

PH₃=8.0 sccm

Power=300 Watts

Pressure=1 Torr

Temperature=300° C.

or

SiH₄=800 sccm

B₂H₆=2.0 sccm

Power=200 Watts

Pressure=1 Torr

Temperature=250° C.

From this layer, cathode tips are fabricated according to many alternative techniques (for example, as seen in U.S. Pat. Nos. 5,229,331; 5,302,238; 5,372,973; and 5,391,259), all of which are incorporated herein by reference.

The advantage of the present invention is three fold:

1. The cap layer covers surface flaws in the glass substrate, which reduces concentration points of local stress and consequently results in more uniform tips.

2. The cap layer also serves as a diffusion barrier against certain contaminants that eventually could cause voids and valleys on the surface of the glass, and again result in tip non-uniformity.

3. The cap layer reduces glass shrinkage and thermal stress significantly. This is especially more evident when silicon tips are deposited on uncoated glass substrates where deposited films delaminate immediately after deposition due to very high thermal stress.

The forgoing illustrative embodiment has been discussed with reference to a glass substrate. It should be noted that the present invention is not restricted to glass but may be used with other inexpensive substrates, such as plastics or any other non conductive materials.

It should also be noted that it would be within the scope of the invention to include a leaching of sodium in the substrate to prevent sodium from moving into the cap layer.

It should be further noted that it is within the scope of the present invention to include an anti-reflective coating or light blocking layer within the cap layer.

The present invention may be subject to many modifications and changes without departing from the spirit or essential, characteristics thereof. The present embodiment should therefor be considered in all respects as being illustrative and not restrictive of the scope of the invention as defined by the appended claims.

We claim:

1. A method of producing an improved cathode substrate for a field emission display comprising the steps of:
providing a substrate;
depositing a cap layer on said substrate; and
forming an array of emitter tips on said substrate.

2. The method according to claim 1 wherein said substrate comprises soda-lime glass.

3. The method according to claim 1 wherein said cap layer is deposited on said substrate by plasma enhanced, chemical vapor deposition.

4. The method according to claim 1 wherein said cap layer has a thickness in the range of 0.1 to 0.5 microns.

5. The method according to claim 1 wherein said cap layer is selected from the group consisting of silicon dioxides silicon nitride, silicon carbide, and diamond-like carbon.

6. The method according to claim 1 wherein said substrate is a plastics material.

7. The method according to claim 1 wherein said substrate is a non-conductive material.

8. The method according to claim 1 further comprising the step of leaching the substrate prior to deposition of said cap layer.

9. The method according to claim 1 further comprising to step of including a light blocking layer within said cap layer.

10. The method according to claim 1 further comprising to step of including an anti-reflective coating within said cap layer.

11. An improved cathode substrate for a field emission display comprising:
a substrate;
a cap layer deposited on said substrate; and
an array of emitter tips formed on said substrate.

12. An improved cathode substrate according to claim 11 wherein said substrate is a soda-lime glass.

13. An improved cathode substrate according to claim 11 wherein said cap layer is deposited on said substrate by plasma enhanced, chemical vapor deposition.

14. An improved cathode substrate according to claim 11 wherein said cap layer has a thickness in the range of 0.1 to 0.5 microns.

15. An improved cathode substrate according to claim 11 wherein said cap layer is selected from the group consisting of silicon dioxide, silicon nitride, silicon carbide, and diamond-like carbon.

16. An improved cathode substrate according to claim 11 wherein said substrate is plastics material.

17. An improved cathode substrate according to claim 11 wherein said substrate is a non-conductive material.

18. An improved cathode substrate according to claim 11 wherein said substrate is leached prior to deposition of said cap layer.

19. An improved cathode substrate according to claim 11 wherein said cap layer includes a light blocking layer.

20. An improved cathode substrate according to claim 11 wherein said cap layer includes an anti-reflective coating.

21. An improved cathode substrate for a field emission display formed by the steps of:
providing a substrate;
depositing a cap layer on said substrate; and
forming an array of emitter tips on said substrate.

22. An improved cathode substrate according to claim 21 wherein said substrate is a soda-lime glass.

23. An improved cathode substrate according to claim 21 wherein said cap layer is deposited on said substrate by plasma enhanced, chemical vapor deposition.

24. An improved cathode substrate according to claim 21 wherein said cap layer has a thickness in the range of 0.1 to 0.5 microns.

25. An improved cathode substrate according to claim 21 wherein said cap layer is selected from the group consisting of silicon dioxide, silicon nitride, silicon carbide, and diamond-like carbon.

26. An improved cathode substrate according to claim 21 wherein said substrate is formed of a plastics material.

27. An improved cathode substrate according to claim 21 wherein said substrate is formed of a non-conductive material.

28. An improved cathode substrate according to claim 21 wherein said substrate is leached prior to deposition of said cap layer.

29. An improved cathode substrate according to claim 21 wherein said cap layer includes a light blocking layer.

30. An improved cathode substrate according to claim 21 wherein said cap layer includes an anti-reflective coating.
